(19) United States
(12) Patent Application Publication
(10) Pub. No.: US 2023/0275706 A1
(43) Pub. Date: Aug. 31, 2023

(54) SIDELINK HARQ FEEDBACK CONTROL METHOD AND DEVICE THEREFOR

(71) Applicant: IUCF-HYU (INDUSTRY-UNIVERSITY COOPERATION FOUNDATION HANYANG UNIVERSITY), Seoul (KR)

(72) Inventors: Sun Woo KIM, Seoul (KR); hyeonjin JUNG, Seoul (KR); Jiseon MOON, Seoul (KR); Junha PARK, Seoul (KR); Hyunwoo PARK, Seoul (KR)

(21) Appl. No.: 18/005,657

(22) PCT Filed: Aug. 9, 2021
(86) PCT No.: PCT/KR2021/010471

§ 371 Date: Jan. 16, 2023

(30) Foreign Application Priority Data
Aug. 7, 2020 (KR) 10-2020-0099444
Aug. 4, 2021 (KR) 10-2021-0102560

(51) Int. Cl. H04L 1/1829; H04W 72/25; H04L 5/00

(52) U.S. Cl. CPC H04L 1/1861; H04W 72/25; H04L 5/0055; H04L 1/1812

(57) ABSTRACT

A method for controlling a sidelink HARQ feedback operation by a UE comprises steps of: receiving, from a transmitting terminal, a physical sidelink control channel (PSCCH) including first sidelink control information; receiving, from the transmitting terminal, a physical sidelink shared channel (PSSCH) including second sidelink control information; and confirming, on the basis of the second sidelink control information, cast type information and HARQ feedback transmission type information about sidelink data received from the transmitting terminal.

### TECHNICAL FIELD

The disclosure relates to a method and device for providing a V2X service in a next-generation radio access technology (new RAT).

### BACKGROUND ART

There is demand for large-capacity data processing, high-rate data processing, and various services using wireless terminals in vehicles and industrial sites. As described above, there is a need for a technology for a high-rate, large-capacity communication system capable of processing various scenarios and large-volume data, such as video, wireless data, and machine-type communication data, beyond a simple voice-oriented service.

To this end, the ITU-R discloses the requirements for adopting the IMT-2020 international standard, and there is being studied for next-generation wireless communication technology to meet the requirements of IMT-2020.

In particular, the 3GPP is conducting research on the LTE-advanced Pro Rel-15/16 standards and the new radio access technology (NR) standard in parallel to meet the requirements for IMT-2020 called 5G technology, and has a plan to approve the two standards as next-generation wireless communication technology.

5G technology may be applied and utilized in autonomous vehicles. For this, it is necessary to apply 5G technology to vehicle-to-everything (V2X) communication, and autonomous driving requires high-rate transmission and reception while guaranteeing high reliability for increasing data.

Further, to meet driving scenarios of various autonomous vehicles, such as platooning, it is required to ensure multicast data transmission/reception as well as unicast data transmission/reception using V2X communication.

In particular, a technique for HARQ operation for securing data transmission reliability while reducing system loads in sidelink communication is required.

### DETAILED DESCRIPTION OF THE INVENTION

### Technical Problem

The present embodiments may provide a method and device for performing sidelink communication using next-generation radio access technology.

### Technical Solution

In an aspect, the present embodiment provides a method for controlling a sidelink HARQ feedback operation by a UE, comprising receiving a physical sidelink control channel (PSCCH) including first sidelink control information from a transmission UE, receiving a physical sidelink shared channel (PSSCH) including second sidelink control information from the transmission UE, and identifying HARQ feedback transmission scheme information and cast type information of sidelink data received from the transmission UE based on the second sidelink control information.

In another aspect, the present embodiment provides a UE controlling a sidelink HARQ feedback operation, comprising a receiver receiving a physical sidelink control channel (PSCCH) including first sidelink control information from a transmission UE and receiving a physical sidelink shared channel (PSSCH) including second sidelink control information from the transmission UE and a controller identifying HARQ feedback transmission scheme information and cast type information of sidelink data received from the transmission UE based on the second sidelink control information.

### Advantageous Effects

According to the present embodiments, there may be provided a method and device for performing sidelink communication using next-generation radio access technology.

### BRIEF DESCRIPTION OF THE DRAWINGS

FIG. 1 is a view schematically illustrating a structure for an NR wireless communication system to which the present embodiments may apply;

FIG. 2 is a view illustrating a frame structure in an NR system to which the present embodiments may apply;

FIG. 3 is a view illustrating a resource grid supported by radio access technology to which the present embodiments may apply;

FIG. 4 is a view illustrating a bandwidth part supported by radio access technology to which the present embodiments may apply;

FIG. 5 is a view exemplarily illustrating a synchronization signal block in radio access technology to which the present embodiments may apply;

FIG. 6 is a view illustrating a random access procedure in radio access technology to which the present embodiments may apply;

FIG. 7 is a view illustrating a CORESET;

FIG. 8 is a view illustrating various scenarios for V2X communication;

FIG. 9 is a view illustrating operations of a UE according to an embodiment;

FIG. 10 is a view illustrating sidelink control information received through PSCCH according to an embodiment;

FIG. 11 is a view illustrating sidelink control information for a second format received through PSSCH according to an embodiment;

FIG. 12 is a view illustrating an operation for calculating distance information based on the locations of a transmission UE and a UE according to an embodiment;

FIG. 13 is a view illustrating an operation for receiving location information about a transmission UE according to an embodiment;

FIG. 14 is a view illustrating an operation for receiving location information about a transmission UE according to another embodiment;

FIG. 15 is a view illustrating an operation for receiving location information about a transmission UE according to another embodiment; and

FIG. 16 is a view illustrating a configuration of a UE according to an embodiment.

### MODE FOR CARRYING OUT THE INVENTION

Hereinafter, embodiments of the disclosure are described in detail with reference to the accompanying drawings. The same or substantially the same reference denotations are used to refer to the same or substantially the same elements throughout the specification and the drawings. When determined to make the subject matter of the present invention unclear, the detailed of the known art or functions may be skipped. The terms “comprises” and/or “comprising,” “has” and/or “having,” or “includes” and/or “including” when used in this specification specify the presence of stated features, regions, integers, steps, operations, elements, and/or components, but do not preclude the presence or addition of one or more other features, regions, integers, steps, operations, elements, components, and/or groups thereof. As used herein, the singular forms “a”, “an” and “the” are intended to include the plural forms as well, unless the context clearly indicates otherwise.

Such denotations as “first,” “second,” “A,” “B,” “(a),” and “(b),” may be used in describing the components of the present invention. These denotations are provided merely to distinguish a component from another, and the essence of the components is not limited by the denotations in light of order or sequence.

In describing the positional relationship between components, when two or more components are described as “connected”, “coupled” or “linked”, the two or more components may be directly “connected”, “coupled” or “linked”, or another component may intervene. Here, the other component may be included in one or more of the two or more components that are “connected”, “coupled” or “linked” to each other.

In relation to components, operational methods or manufacturing methods, when A is referred to as being “after,” “subsequent to,” “next,” and “before,” A and B may be discontinuous from each other unless mentioned with the term “immediately” or “directly.”

When a component is designated with a value or its corresponding information (e.g., level), the value or the corresponding information may be interpreted as including a tolerance that may arise due to various factors (e.g., process factors, internal or external impacts, or noise).

In the disclosure, ‘wireless communication system’ means a system for providing various communication services, such as voice and data packets, using a radio resource and may include a UE, a base station, or a core network.

The present embodiments disclosed below may be applied to wireless communication systems using various radio access technologies. For example, the present embodiments may be applied to various radio access technologies, such as code division multiple access (CDMA), frequency division multiple access (FDMA), time division multiple access (TDMA), orthogonal frequency division multiple access (OFDMA), single carrier frequency division multiple access (SC-FDMA), or non-orthogonal multiple access (NOMA). Further, radio access technology may mean not only a specific access technology, but also a communication technology for each generation established by various communication organizations, such as 3GPP, 3GPP2, Wi-Fi, Bluetooth, IEEE, and ITU. For example, CDMA may be implemented as radio technology, such as universal terrestrial radio access (UTRA) or CDMA2000. TDMA may be implemented as GSM (global system for mobile communications)/GPRS (general packet radio service)/EDGE (enhanced data rates for GSM evolution). OFDMA may be implemented with a wireless technology, such as institute of electrical and electronic engineers (IEEE) 802.11 (Wi-Fi), IEEE 802.16 (WiMAX), IEEE 802-20, evolved UTRA (E-UTRA), and the like. IEEE 802.16m is an evolution of IEEE 802.16e, and provides backward compatibility with IEEE 802.16e-based systems. UTRA is part of UMTS (universal mobile telecommunications system). 3GPP (3rd generation partnership project) LTE (long term evolution) is part of E-UMTS (evolved UMTS) using evolved-UMTS terrestrial radio access (E-UTRA) and adopts OFDMA for downlink and SC-FDMA for uplink. As such, the present embodiments may be applied to currently disclosed or commercialized radio access technologies and may also be applied to radio access technologies currently under development or to be developed in the future.

Meanwhile, in the disclosure, ‘UE’ is a comprehensive concept meaning a device including a wireless communication module that communicates with a base station in a wireless communication system and should be interpreted as a concept that may include not only user equipment (UE) in, e.g., WCDMA, LTE, NR, HSPA, and IMT-2020 (5G or new radio), but also a mobile station (MS), user terminal (UT), subscriber station (SS), or wireless device in GSM. Further, the UE may be a user portable device, such as a smartphone, according to the usage type and, in the V2X communication system, the UE may mean a vehicle or a device including a wireless communication module in the vehicle. Further, in the case of a machine type communication system, the UE may mean an MTC terminal, M2M terminal, or URLLC terminal equipped with a communication module to perform machine type communication.

In the disclosure, ‘base station’ or ‘cell’ refers to a terminal that communicates with a UE in terms of a network and in concept encompasses various coverage areas, such as node-B, evolved node-B (eNB), gNode-B (gNB), low power node (LPN), sector, site, various types of antennas, base transceiver system (BTS), access point, point (e.g. transmission point, reception point, or transmission/reception point), relay node, mega cell, macro cell, micro cell, pico cell, femto cell, remote radio head (RRH), radio unit (RU), or small cell. Further, ‘cell’ may mean one including a bandwidth part (BWP) in the frequency domain. For example, ‘serving cell’ may mean the activation BWP of the UE.

Since there is a base station controlling one or more cells in the various cells enumerated above, the base station may be interpreted in two meanings. The base station may be 1) a device itself which provides a mega cell, a macro cell, a micro cell, a pico cell, a femto cell, or a small cell in relation to the radio region, or 2) the radio region itself. In 1), all devices that provide a predetermined radio region and are controlled by the same entity or interact to configure a radio region via cooperation are denoted as base stations. An embodiment of the base station is a transmission/reception point, transmission point, or reception point depending on the scheme of configuring the radio region. In 2), the radio region itself, in which a signal is received or transmitted from the point of view of the UE or a neighboring base station may be the base station.

In the disclosure, ‘cell’ may mean the coverage of the signal transmitted from the transmission/reception point, a component carrier having the coverage of the signal transmitted from the transmission/reception point (transmission point or transmission/reception point), or the transmission/reception point itself.

Uplink (UL) means a scheme for transmitting/receiving data to and from the base station by the UE, and downlink (DL) means a scheme for transmitting/receiving data to/from the UE by the base station. Downlink may mean communication or communication path from the multiple transmission/transmission points to the UE, and uplink may mean communication or communication path from the UE to the multiple transmission/reception points. In this case, in the downlink, the transmitter may be part of the multiple transmission/reception points, and the receiver may be part of the UE. Further, in the uplink, the transmitter may be part of the UE, and the receiver may be part of the multiple transmission/reception points.

Uplink and downlink transmits/receives control information through a control channel, such as physical downlink control channel (PDCCH) or physical uplink control channel (PUCCH) and configures a data channel, such as physical downlink shared channel (PDSCH) or physical uplink shared channel (PUSCH) to transmit/receive data. Hereinafter, the context in which signals are transmitted/received through a channel, such as PUCCH, PUSCH, PDCCH, and PDSCH, is expressed as ‘transmitting or receiving PUCCH, PUSCH, PDCCH, and PDSCH.’

Although the technical spirit is described focusing primarily on the 3GPP LTE/LTE-A/new RAT (NR) communication system for clarity of description, the technical features are not limited to such communication system.

The 3GPP develops 5th-generation (5G) communication technology to meet the requirements of ITU-R's next-generation radio access technology after research on 4th-generation (4G) communication technology. Specifically, the 3GPP develops new NR communication technology separate from LTE-A pro and 4G communication technology, which have enhanced LTE-advanced technology to meet the requirements of ITU-R, as 5G communication technology. Both LTE-A pro and NR refer to 5G communication technologies. Hereinafter, 5G communication technology is described focusing on NR unless specified as a specific communication technology.

Operating scenarios in NR define various operating scenarios by adding considerations of satellites, automobiles, and new verticals in the existing 4G LTE scenarios and, from a service point of view, supports the enhanced mobile broadband (eMBB) scenario, the massive machine communication (mMTC) scenario that has high UE density but is deployed in a wide range to requires a low data rate and asynchronous access, and the ultra-reliability and low latency (URLLC) scenario that requires high responsiveness and reliability and may support high-speed mobility.

To meet such scenarios, NR discloses wireless communication systems that adopt a new waveform and frame structure technology, low-latency technology, ultra-high frequency band (mmWave) supporting technology, and forward compatibility providing technology. In particular, the NR system suggests various technical changes in terms of flexibility to provide forward compatibility. The main technical features of NR are described below with reference to the drawings.

<Overview of NR System>

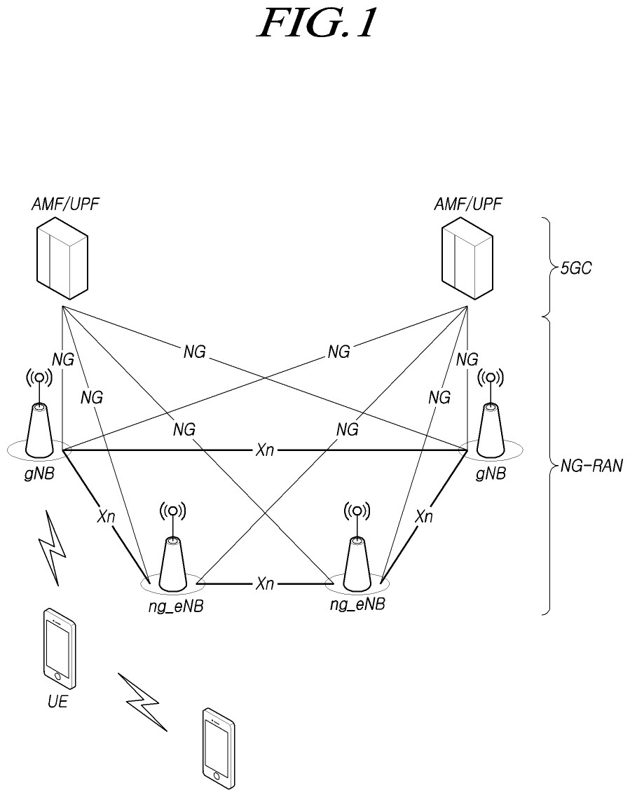

FIG. 1 is a view schematically illustrating a structure for an NR system to which the present embodiments may apply.

Referring to FIG. 1, the NR system is divided into a 5G core network (5GC) and an NR-RAN part. The NG-RAN is constituted of gNB and ng-eNBs providing user plane (SDAP/PDCP/RLC/MAC/PHY) and user equipment (UE) control plane (RRC) protocol termination. The gNBs or the gNBs and the ng-eNBs are interconnected through the Xn interface. The gNB and the ng-eNB are connected to the 5GC through the NG interface. The 5GC may include an access and mobility management function (AMF) which is in charge of the control plane, such as UE access and mobility control function, and a user plane function (UPF) which is in charge of the user data control function. NR supports both the below-6 GHz frequency band (Frequency Range 1 (FR1) and above-6 GHz frequency band (Frequency Range 2 (FR2)).

The gNB means a base station that provides the UE with NR user plane and control plane protocol termination, and the ng-eNB means a base station that provides the UE with the E-UTRA user plane and control plane protocol termination. In the disclosure, the base station should be understood as encompassing gNB and ng-eNB and, as necessary, be used to separately denote gNB or ng-eNB.

<NR Waveform, Numerology, and Frame Structure>

NR uses the CP-OFDM waveform using the cyclic prefix for downlink transmission and CP-OFDM or DFT-s-OFDM for uplink transmission. OFDM technology is easily combined with multiple input multiple output (MIMO) and has the advantages of high frequency efficiency and capability of using a low-complexity receiver.

Meanwhile, since, in NR, the above-described three scenarios have different requirements for data rate, latency, and coverage, it is needed to efficiently meet the requirements for each scenario through the frequency band constituting any NR system. To that end, there has been proposed technology for efficiently multiplexing radio resources based on a plurality of different numerologies.

Specifically, the NR transmission numerology is determined based on the subcarrier spacing and cyclic prefix (CP) and, as shown in Table 1 below, it is exponentially changed, with the exponent value of 2 used as u with respect to 15 kHz.

TABLE 1

| | subcarrier | | Supported | Supported |
|---|---|---|---|---|
| μ | spacing | Cyclic prefix | for data | for synch |
| 0 | 15 | normal | Yes | Yes |
| 1 | 30 | normal | Yes | Yes |
| 2 | 60 | Normal, Extended | Yes | No |
| 3 | 120 | normal | Yes | Yes |
| 4 | 240 | normal | No | Yes |

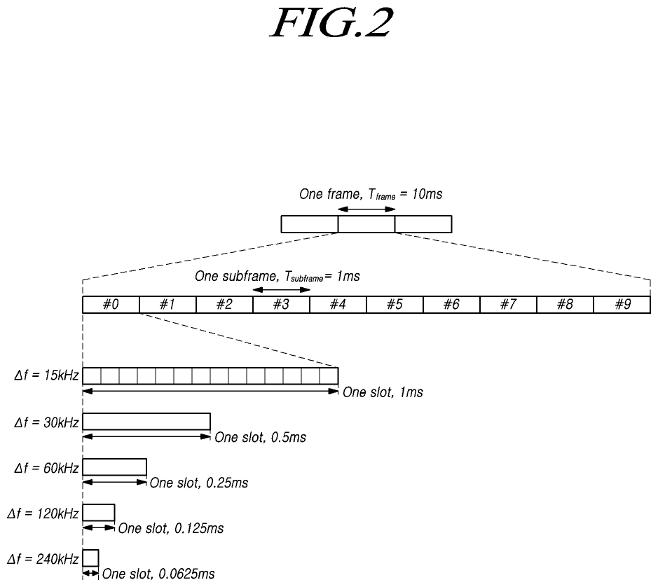

As shown in Table 1 above, the NR numerologies may be divided into five types depending on the subcarrier spacing. This differs from the subcarrier spacing fixed to 15 kHz in LTE which is one 4G communication technology. Specifically, in NR, the subcarrier spacings used for data transmission are 15, 30, 60, and 120 khz, and the subcarrier spacings used for synchronization signal transmission are 15, 30, 12, and 240 khz. Further, the extended CP is applied only to the 60 khz subcarrier spacing. Meanwhile, as the frame structure in NR, a frame having a length of 10 ms, which is constituted of 10 subframes having the same length of 1 ms, is defined. One frame may be divided into half frames of 5 ms, and each half frame may include 5 subframes. In the case of the 15 khz subcarrier spacing, one subframe is constituted of one slot, and each slot is constituted of 14 OFDM symbols. FIG. 2 is a view illustrating a frame structure in an NR system to which the present embodiments may apply.

Referring to FIG. 2, a slot is fixedly composed of 14 OFDM symbols in the case of the normal CP, but the length of the slot in the time domain may vary depending on the subcarrier spacing. For example, in the case of a numerology having a 15 khz subcarrier spacing, a slot has the same length as the subframe, as the length of 1 ms. In contrast, in the case of a numerology having a 30 khz subcarrier spacing, a slot is constituted of 14 OFDM symbols, but two slots may be included in one subframe, as the length of 0.5 ms. In other words, the subframe and the frame are defined as having a fixed length, and the slot is defined with the number of symbols, and the temporal length may vary depending on the subcarrier spacing.

Meanwhile, NR defined a slot as the basic unit for scheduling and, to reduce transmission latency in the radio section, adopted minislot (or subslot or non-slot based schedule). If a wide subcarrier spacing is used, the length of one slot is inverse-proportionally shortened, so that it is possible to reduce transmission latency in the radio section. The minislot is for efficient support of the URLLC scenario and enables scheduling in the units of 2, 4, or 7 symbols.

Further, NR defined uplink and downlink resource allocation as the symbol level in one slot, unlike LTE. To reduce HARQ latency, a slot structure has been defined which enables HARQ ACK/NACK to be transmitted directly in the transmission slot, and such slot structure is referred to as a self-contained structure in the description.

NR has been designed to be able to support a total of 256 slots and, among them, 62 slot formats are used in 3GPP Rel-15. Further, a common frame structure constituting the FDD or TDD frame is supported through a combination of various slots. For example, a slot structure in which the symbols of the slot all are configured as downlink, a slot structure in which all the symbols are configured as uplink, and a slot structure in which downlink symbols and uplink symbols are combined are supported. Further, NR supports data transmission that is distributed and scheduled in one or more slots. Therefore, the base station may inform the UE whether the slot is a downlink slot, uplink slot, or flexible slot using the slot format indicator (SFI). The base station may indicate the slot format by indicating the index of the table configured through UE-specific RRC signaling, by the SFI and may indicate it dynamically through downlink control information (DCI) or statically or semi-statically through RRC.

<NR Physical Resource>

In connection with the physical resource in NR, antenna port, resource grid, resource element, resource block, and bandwidth part are taken into consideration.

The antenna port is defined so that the channel carrying a symbol on the antenna port may be inferred from the channel carrying another symbol on the same antenna port. Where the large-scale property of the channel carrying a symbol on one antenna port may be inferred from the channel carrying a symbol on a different antenna port, the two antenna ports may be said to have a QC/QCL (quasi co-located or quasi co-location) relationship. Here, the large-scale properties include one or more of delay spread, Doppler spread, frequency shift, average received power, and received timing.

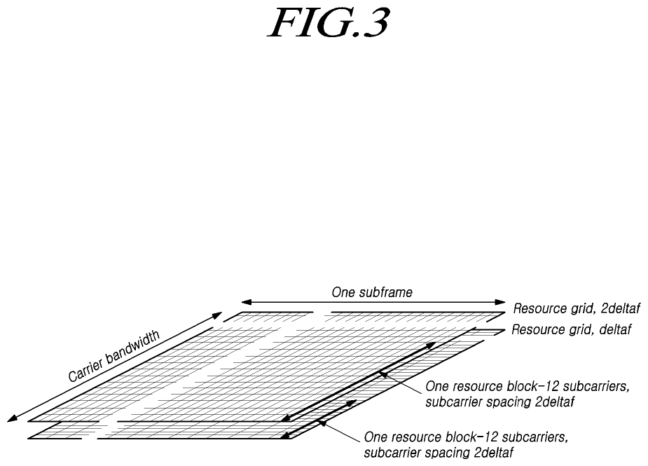

FIG. 3 is a view illustrating a resource grid supported by radio access technology to which the present embodiments may apply.

Referring to FIG. 3, since NR supports a plurality of numerologies in the same carrier, a resource grid may exist depending on each numerology. Further, the resource grid may exist depending on the antenna port, subcarrier spacing, or transmission direction.

The resource block is constituted of 12 subcarriers and is defined only in the frequency domain. Further, the resource element is constituted of one OFDM symbol and one subcarrier. Therefore, as shown in FIG. 3, the size of one resource block may vary depending on the subcarrier spacing. Further, in NR, “point A”, which serves as a common reference point for the resource block grid, and common resource block and virtual resource block are defined.

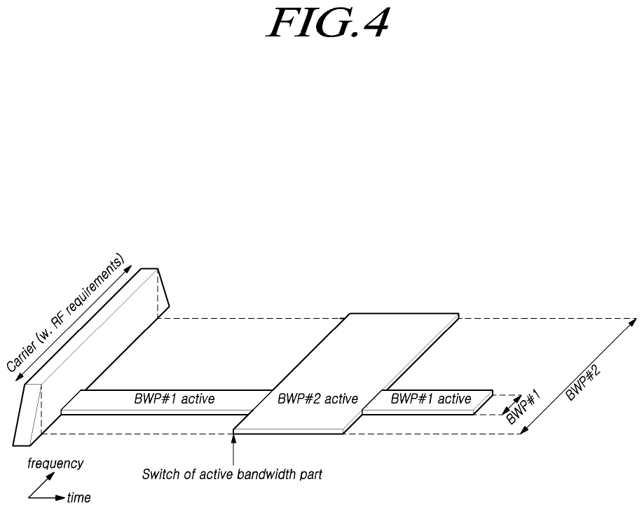

FIG. 4 is a view illustrating a bandwidth part supported by radio access technology to which the present embodiments may apply.

In NR, unlike LTE where the carrier bandwidth is fixed to 20 Mhz, the maximum carrier bandwidth from 50 Mhz to 400 Mhz is set for each subcarrier spacing. Therefore, it is not assumed that all UEs use all of these carrier bandwidths. Accordingly, in NR, as shown in FIG. 4, a bandwidth part (BWP) may be designated within the carrier bandwidth and used by the UE. Further, the bandwidth part is associated with one numerology and is composed of a subset of contiguous common resource blocks and may be activated dynamically over time. Up to four bandwidth parts may be configured in the UE for each of uplink and downlink. Data is transmitted/received using the bandwidth part activated at a given time.

In the case of paired spectra, the uplink and downlink bandwidth parts are set independently, and in the case of unpaired spectra, the bandwidth parts of uplink and downlink are set to make a pair to share the center frequency so as to prevent unnecessary frequency re-tunning between downlink and uplink operations.

<NR Initial Access>

In NR, the UE performs a cell search and random access procedure to access the base station and perform communication.

Cell search is a procedure in which the UE is synchronized with the cell of the base station using the synchronization signal block (SSB) transmitted from the base station, obtains the physical layer cell ID, and obtains system information.

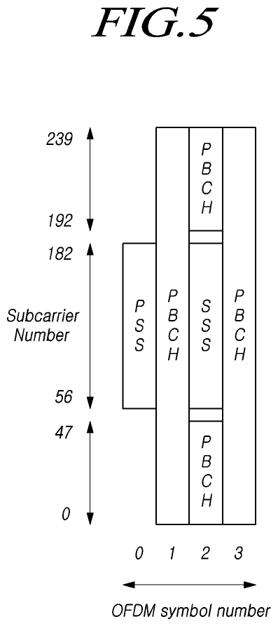

FIG. 5 is a view exemplarily illustrating a synchronization signal block in radio access technology to which the present embodiments may apply.

Referring to FIG. 5, the SSB is constituted of a primary synchronization signal (PSS) and a secondary synchronization signal (SSS) occupying 1 symbol and 127 subcarriers, respectively, and a PBCH spanning 3 OFDM symbols and 240 subcarriers.

The UE monitors the SSB in time and frequency domains and receives the SSB.

The SSB may be transmitted up to 64 times in 5 ms. Multiple SSBs are transmitted on different transmission beams within 5 ms time, and the UE performs detection assuming that SSBs are transmitted every 20 ms period based on one specific beam used for transmission. The number of beams available for SSB transmission within 5 ms may increase as the frequency band increases. For example, up to 4 SSB beams may be transmitted below 3 GHz, SSBs may be transmitted using up to 8 different beams in a frequency band of 3 to 6 GHz, and up to 64 different beams in a frequency band of 6 GHz or higher.

Two SSBs are included in one slot, and the start symbol and number of repetitions within the slot are determined according to the subcarrier spacing as follows.

Meanwhile, the SSB is not transmitted at the center frequency of the carrier bandwidth unlike the SS of conventional LTE. In other words, the SSB may be transmitted even in a place other than the center of the system band and, in the case of supporting wideband operation, a plurality of SSBs may be transmitted in the frequency domain. Accordingly, the UE monitors the SSB by a synchronization raster, which is a candidate frequency location for monitoring the SSB. The carrier raster and synchronization raster, which are the center frequency location information about the channel for initial access, are newly defined in NR, and the synchronization raster has a wider frequency interval than the carrier raster, enabling the UE to do a fast SSB search.

The UE may obtain the MIB through the PBCH of the SSB. The master information block (MIB) includes minimum information for the UE to receive remaining system information (remaining minimum system information (RMSI) broadcast by the network. Further, the PBCH may include information about the position of the first DM-RS symbol in the time domain, information for monitoring SIB1 by the UE (e.g., SIB1 numerology information, information related to SIB1 CORESET, search space information, PDCCH-related parameter information, etc.), offset information between the common resource block and the SSB (the absolute location of the SSB within the carrier is transmitted through SIB1), and the like. Here, the SIB1 numerology information is equally applied to some messages used in the random access procedure for the UE to access the base station after completing the cell search procedure. For example, the numerology information about SIB1 may be applied to at least one of messages 1 to 4 for the random access procedure.

The above-described RMSI may mean system information block 1 (SIB1). SIB1 is broadcast periodically (e.g., 160 ms) in the cell. SIB1 includes information necessary for the UE to perform an initial random access procedure, and is periodically transmitted through the PDSCH. To receive SIB1, the UE needs to receive numerology information used for SIB1 transmission and control resource set (CORESET) information used for SIB1 scheduling through the PBCH. The UE identifies scheduling information for SIB1 using SI-RNTI in CORESET and obtains SIB1 on PDSCH according to scheduling information. The remaining SIBs except for SIB1 may be transmitted periodically and may be transmitted at the request of the UE.

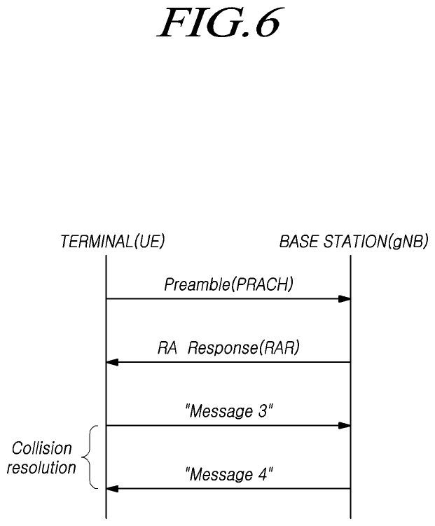

FIG. 6 is a view illustrating a random access procedure in radio access technology to which the present embodiments may apply.

Referring to FIG. 6, if the cell search is completed, the UE transmits a random access preamble for random access to the base station. The random access preamble is transmitted through PRACH. Specifically, the random access preamble is transmitted to the base station through the PRACH composed of contiguous radio resources in a periodically repeated specific slot. In general, when the UE initially accesses the cell, a contention-based random access procedure is performed, and when random access is performed for beam failure recovery (BFR), a non-contention-based random access procedure is performed.

The UE receives a random access response to the transmitted random access preamble. The random access response may include a random access preamble identifier (ID), uplink radio resource (UL grant), temporary cell-radio network temporary identifier (C-RNTI), and time alignment command (TAC). Since one random access response may include random access response information for one or more UEs, the random access preamble identifier may be included to indicate to which UE the included UL grant, temporary C-RNTI, and TAC are valid. The random access preamble identifier may be an identifier for the random access preamble received by the base station. The TAC may be included as information for the UE to adjust uplink synchronization. The random access response may be indicated by the random access identifier on the PDCCH, that is, the random access-radio network temporary identifier (RA-RNTI).

Upon receiving a valid random access response, the UE processes information included in the random access response and performs scheduled transmissions to the base station. For example, the UE applies the TAC and stores the temporary C-RNTI. Further, the UE transmits data stored in the buffer of the UE or newly generated data to the base station using the UL grant. In this case, information that may identify the UE should be included.

Finally, the UE receives a downlink message for contention resolution.

<NR CORESET>

In NR, the downlink control channel is transmitted in a control resource set (CORESET) having a length of 1 to 3 symbols and transmits uplink/downlink scheduling information, slot format index (SFI), transmit power control (TPC) information, etc.

As such, NR introduced the concept of CORESET to secure the flexibility of the system. The control resource set (CORESET) means a time-frequency resource for a downlink control signal. The UE may use one or more search spaces in CORESET time-frequency resources to decode control channel candidates. A quasi co-location (QCL) assumption for each CORESET has been set, which is used for the purpose of indicating the characteristics of the analog beam direction in addition to the latency spread, Doppler spread, Doppler shift, and average latency, which are characteristics assumed by the conventional QCL.

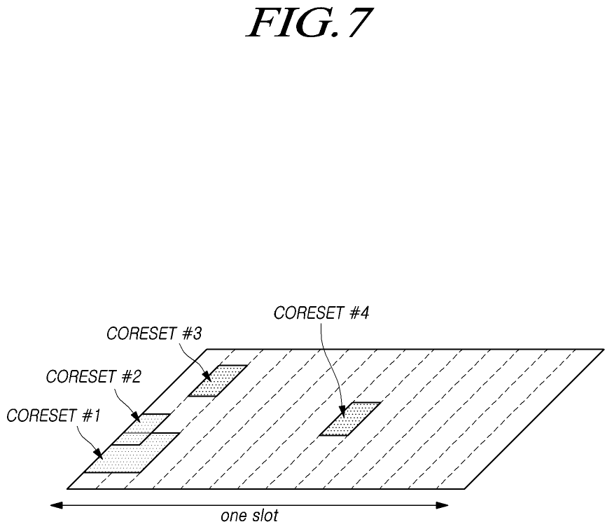

FIG. 7 is a view illustrating a CORESET.

Referring to FIG. 7, the CORESET may exist in various forms within a carrier bandwidth within one slot. In the time domain, the CORESET may be constituted of up to 3 OFDM symbols. Further, the CORESET is defined as a multiple of 6 resource blocks up to the carrier bandwidth in the frequency domain.

The first CORESET is indicated through the MIB as part of the initial bandwidth part configuration to allow additional configuration and system information to be received from the network. After connection setup with the base station, the UE may receive and configure one or more CORESET information through RRC signaling.

As used herein, the frequency, frame, subframe, resource, resource block, region, band, subband, control channel, data channel, synchronization signal, various reference signals, various signals, and various messages related to new radio (NR) may be interpreted in various meanings as currently used or to be used in the future.

<Sidelink>

In the conventional LTE system, for direct communication between UEs and providing a V2X (particularly V2V) service, a radio channel and radio protocol have been designed for inter-UE direct communication (i.e., sidelink).

In relation to the sidelink, S-PSS/S-SSS, which is a synchronization signal for synchronization between a wireless sidelink transmitting end and a receiving end, and physical sidelink broadcasting channel (PSBCH) for transmitting and receiving a sidelink master information block (MIB) related thereto have been defined, and physical sidelink discovery channel (PSDCH), physical sidelink control channel (PSCCH) for sidelink control information (SCI) transmission/reception, and physical sidelink shared channel (PSSCH) have been designed.

Further, to allocate a radio resource for sidelink, technology has been developed separately into mode 1 in which the base station allocates a radio resource and mode 2 in which the UE selects and allocates one from a radio resource pool. Further, the LTE system required an additional technical evolution to meet the V2X scenario.

In this environment, 3GPP derived 27 service scenarios related to vehicle recognition in Rel-14 and determined the main performance requirements according to road conditions. Further, in the recent Rel-15, 25 more advanced service scenarios, such as platooning, advanced driving, and long-distance vehicle sensors, were derived, and six performance requirements were determined.

To meet these performance requirements, technology development has been conducted to enhance the performance of sidelink technology developed based on conventional D2D communication to meet the requirements of V2X. In particular, to apply to cellular-V2X (C-V2X), a technology that enhances the physical layer design of sidelink to be suitable for a high-speed environment, resource allocation technology, and synchronization technology may be selected as major research technologies.

The sidelink described below may be understood as encompassing links used for D2D communication developed after 3GPP Rel-12, V2X communication after Rel-14, and NR V2X after Rel-15. Further, each channel term, synchronization term, and resource term are described with the same terms regardless of D2D communication requirements and V2X Rel-14 and 15 requirements. However, for convenience of understanding, the differences of sidelinks meeting V2X scenario requirements from the sidelinks for D2D communication in Rel-12/13 are mainly described as necessary. Accordingly, the sidelink-related terms described below are divided merely for D2D communication/V2X communication/C-V2X communication for convenience of understanding and comparison, and are not limited to a specific scenario.

<Resource Allocation>

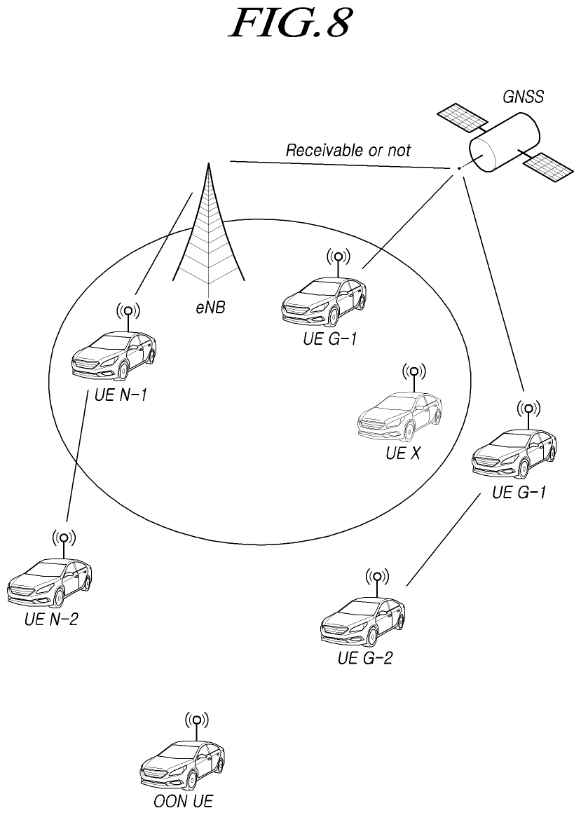

FIG. 8 is a view illustrating various scenarios for V2X communication.

Referring to FIG. 8, a V2X UE (marked as a vehicle, but may be set in various ways, such as UE) may be positioned within or outside the coverage of the base station (eNB or gNB or ng-eNB). For example, communication may be performed between UEs (UE N-1, UE G-1, and UE X) within the coverage of the base station, or communication may be performed between a UE within the coverage of the base station and a UE outside (e.g., UE N-1, UE N-2). Or, communication may be performed between UEs (e.g., UE G-1 and UE G-2) outside the coverage of the base station.

In these various scenarios, allocation of radio resources for communication is required in order for the corresponding UE to perform communication using the sidelink, and the allocation of radio resources largely includes base station handling allocation and UE self-selection and allocation.

Specifically, the scheme in which the UE allocates resources in the sidelink includes a scheme in which the base station involves in selection and management of resources (mode 10 and a scheme in which the UE itself selects resources (mode 2). In mode 1, the base station schedules a scheduling assignment (SA) pool resource region and a DATA pool resource region allocated thereto to the transmission UE.

Meanwhile, the resource pool may be subdivided into several types. First, the resource pool may be divided according to the contents of the sidelink signal transmitted in each resource pool. For example, the contents of the sidelink signal may be divided, and for each, a separate resource pool may be configured. As the contents of the sidelink signal, there may be a scheduling assignment (SA), a sidelink data channel, and a discovery channel.

The SA may be a signal including information such as the position of the resource used by the transmission UE in transmission of the following sidelink data channel and modulation and coding scheme (MCS) or MIMO transmission scheme necessary for modulation of other data channels, and timing advance (TA). This signal may be multiplexed with the sidelink data on the same resource unit and transmitted and, in this case, the SA resource pool may mean a pool of resources in which the SA is multiplexed with the sidelink data and transmitted.

Meanwhile, the FDM scheme applied to V2X communication may reduce the latency time when a data resource is allocated after SA resource allocation. For example, a non-adjacent scheme of separating the control channel resource and the data channel resource in one subframe in the time domain and an adjacent scheme in which the control channel and the data channel are contiguously allocated in one subframe are considered.

Meanwhile, when the SA is multiplexed and transmitted with the sidelink data on the same resource unit, only sidelink data channel except for the SA information may be transmitted in the resource pool for the sidelink data channel. In other words, the resource elements which have been used to transmit SA information on the individual resource unit in the SA resource pool may still be used to transmit sidelink data in the sidelink data channel resource pool. The discovery channel may be a resource pool for messages to allow the transmission UE to transmit its ID or such information to be discovered by the adjacent UE. Even when the contents of the sidelink signal are the same, different resource pools may be used depending on the transmission/reception attributes of the sidelink signal.

As an example, despite the sidelink data channel or discovery message, they may be divided into different resource pools depending on sidelink signal transmission timing determination schemes (e.g., whether it is transmitted at the time of reception of a sync reference signal or it is transmitted, with a predetermined TA applied), resource allocation schemes (e.g., whether the base station designates the transmission resources of individual signals for UE or individual transmission UEs select individual signal transmission resources on their own), signal formats (e.g., the number of symbols each sidelink signal occupies in one subframe or the number of subframes used for transmission of one sidelink signal), signal strengths from the base station, or the transmit power strengths of sidelink UE.

<Synchronization Signal>

As described above, a sidelink communication UE is highly likely to be positioned outside the base station coverage. Even in this case, communication using the side link should be performed. To this end, the issue of obtaining synchronization by the UE positioned outside the base station coverage is important.

A method for synchronization in time and frequency in sidelink communication, particularly communication between vehicles, between a vehicle and another UE, and between a vehicle and the infrastructure network is described based on the foregoing description.

D2D communication used a sidelink synchronization signal (SLSS), which is a synchronization signal transmitted from the base station for time synchronization between UEs. In C-V2X, a satellite system (global navigation satellite system (GNSS) may be additionally considered to enhance synchronization performance. However, priority may be given to synchronization establishment or the base station may indicate priority information. For example, the UE first selects the synchronization signal directly transmitted by the base station in determining transmission synchronization of the UE and, if the UE is positioned at the edge of the coverage of the base station, synchronization is preferentially made preferentially with the SLSS transmitted by the UE inside the coverage of the base station.

Meanwhile, the wireless UE installed in the vehicle or the UE mounted in the vehicle is relatively less susceptible to the battery consumption issue and may use satellite signals, such as GPS, for navigation purposes, and may thus use satellite signals in establishing synchronization in time and frequency between UEs. Here, the satellite signals may be GNSS signals, such as global navigation satellite system (GLONAS), GALILEO, and BEIDOU in addition to the exemplified global positioning system (GPS).

Meanwhile, sidelink synchronization signals may include a sidelink primary synchronization signal (S-PSS) and a sidelink secondary synchronization signal (S-SSS). The S-PSS may have a Zadoff-chu sequence of a predetermined length or a similar/modified/repeated structure of the PSS. Further, unlike the DL PSS, other Zadoff Chu root indexes (e.g., 26 and 37) may be used. The S-SSS may have a similar/modified/repeated structure of the SSS or the M-sequence. If the UEs are synchronized from the base station, the SRN becomes the base station, and the sidelink synchronization signal (S-SS) becomes the PSS/SSS.

Unlike DL PSS/SSS, S-PSS/S-SSS follows the UL subcarrier mapping scheme. The physical sidelink broadcast channel (PSBCH) may be a channel where basic system information that the UE needs to know first before transmitting and receiving sidelink signals (e.g., information related to S-SS, duplex mode (DM), TDD UL/DL configuration, resource pool related information, type of application related to S-SS, subframe offset, broadcast information, etc.) is transmitted. The PSBCH may be transmitted on the same subframe as the S-SS or on a subsequent subframe. The DMRS may be used for demodulation of PSBCH. The S-SS and PSBCH may be referred to as sidelink synchronization signal block (S-SSB).

The SRN may be a node transmitting S-SS and PSBCH. The S-SS may have a specific sequence form. The PSBCH may have a form of a sequence indicating specific information or a codeword that has undergone predetermined channel coding. Here, the SRN may be a base station or a specific sidelink UE. In the case of partial network coverage or out of network coverage, the UE may become the SRN.

Further, the S-SS may be relayed for sidelink communication with out-of-coverage UEs as needed and be relayed through multiple hops. In the following description, relaying a synchronization signal is a concept that includes not only directly relaying a synchronization signal of a base station but also transmitting a sidelink synchronization signal in a separate format according to the synchronization signal reception time. As the sidelink synchronization signal is so relayed, the in-coverage UE and the out-of-coverage UE may directly communicate.

<NR Sidelink>

As described above, unlike V2X based on the LTE system, there is a demand for NR-based V2X technology to meet complex requirements, such as of autonomous driving.

NR V2X intends to flexibly provide V2X services in more diverse environments by applying the frame structure, numerology, and channel transmission and reception procedures of NR. To this end, development of technologies, such as a resource sharing technology between a base station and a UE, a sidelink carrier aggregation (CA) technology, a partial sensing technology for a pedestrian UE, and sTTI is required.

NR V2X is determined to support unicast and group cast as well as broadcast used in LTE V2X. In this case, for groupcast and unicast, the target group ID is determined to be used, but whether to use the source ID is determined to be discussed later.

Further, as HARQ for QoS is supported, control information is determined to include the HARQ process ID as well. In LTE HARQ, the PUCCH for HARQ is transmitted four subframes after downlink transmission. However, in NR HARQ, the PUCCH resource and feedback timing may be indicated by the PUCCH resource indicator or PDSCH-to-HARQ feedback timing indicator in, e.g., DCI format 1_0 or 1_1.

In LTE V2X, separate HARQ ACK/NACK information was not transmitted to reduce system overhead, and for data transmission stability, the transmission UE was determined to be able to retransmit data once according to its selection. However, NR V2X is able to transmit HARQ ACK/NACK information in light of data transmission stability and, in this case, bundle and transmit information, reducing overhead.

In other words, the transmission UE UE1 may transmit three data to the reception UE UE2 and, if the reception UE generates HARQ ACK/NACK information in response, the information may be bundled and transmitted through the PSCCH.

Meanwhile, in FR1 for the frequency domain below 3 GHz, it was determined to later discuss 15 kHz, 30 kHz, 60 kHz, and 120 kHz as subcarrier spacing (SCS) candidates. Further, for FR2 for the frequency domain above 3 GHz, it was determined to discuss 30 kHz, 60 kHz, 120 kHz, and 240 kHz as subcarrier spacing (SCS) candidates. NR V2X may support minislots (e.g., 2/4/7 symbols) smaller than 14 symbols as the minimum scheduling unit.

As RS candidates, DM-RS, PT-RS, CSI-RS, SRS, and AGC training signals were determined to be discussed.

Sidelink UL SPS

In general, UL transmission using SPS may cause some latency when the gap between user data generation and configured SPS resources is large. Therefore, when SPS is used for latency-sensitive traffic, such as sidelink communication, the SPS scheduling interval should be small enough to support the latency requirements.

However, a smaller SPS scheduling interval may result in more overhead since the UE may not fully utilize the configured SPS resources. Therefore, the gap between user data generation and the configured SPS resources should be small, and the SPS scheduling interval should be suitable to meet the latency requirements. Currently, there is no mechanism to support this feature.

The UE may receive an SPS configuration for one or more specific logical channels. The UE may receive SPS configuration for a specific logical channel through system information, an RRC connection setup message, an RRC connection reconfiguration message or an RRC connection release message.

When data is available for a specific logical channel(s), the UE may request the base station to activate SPS and then perform UL transmission using the configured SPS resources according to the SPS activation command received from the base station. The UE may transmit an SPS activation request to the base station through a physical uplink control channel (PUCCH), MAC control element (CE) or RRC message. In other words, the UE may transmit an SPS activation request to the base station using control resources used for requesting SPS activation. The control resource may be a PUCCH resource, a random access resource, or a new UL control channel resource. Further, the UE may transmit an SPS activation request to the base station during, e.g., RRC connection (re-)establishment, during handover, after handover, or in RRC_CONNECTED.

Since the UE actively requests SPS activation from the base station when there is UL data to be transmitted, the gap between the generation of UL data and configured SPS resources may be reduced.

For example, the UE receives SPS configuration information including three SPS configurations from the base station. If there is UL data to be transmitted in the upper layer, the UE transmits an SPS request message to the base station through a MAC CE, for example. The base station sends an Ack message for one of the three SPS configurations. The UE transmits UL data through a specific resource, e.g., in a 1 sec period, according to the corresponding SPS configuration.

Meanwhile, if there is UL data to be transmitted in the upper layer at a specific time, the UE transmits again an SPS request message to the base station through a MAC CE, for example. The base station sends an Ack message for another one of the three SPS configurations. The UE transmits UL data through a specific resource, e.g., in a 100 sec period, according to the corresponding SPS configuration.

Meanwhile, S-SS id_net is a set of S-SS IDs used by UEs that have selected the synchronization signal of the base station as a synchronization reference among physical layer SLSS IDs {0, 1, . . . , 335} and may be {0, 1, . . . , 167}. Further, S-SS id_oon is a set of S-SS IDs used when the base stations/out-of-coverage UEs transmit synchronization signals by themselves, and may be {168, 169, . . . , 335}.

As described above, unlike conventional signal transmission and reception between a base station and a UE, sidelink communication between UEs performs resource allocation, time synchronization setting, and reference signal transmission independently or in conjunction with the base station.

In particular, in the case of next-generation radio access technology (including terms, such as NR and 5G), a number of protocols between the base station and the UE have been added/modified. Therefore, unlike the conventional LTE technology-based V2X communication protocol, NR technology-based sidelink communication also requires development of various protocols.

In the disclosure, there are proposed operations, such as PSCCH, PSSCH, or DMRS configuration, resource allocation, and synchronization signal reception when the transmission UE and the reception UE perform sidelink communication. Each embodiment below is described focusing on sidelink communication, but may also be applied to C-V2X and D2D communication as described above.

As the subcarrier spacing (SCS) of the OFDM communication system is varied in NR, the frame structure of the sidelink to be used for information transmission and reception in sidelink communication needs to be changed as well.

In the present embodiments, the sidelink signal may use the CP-OFDM-type waveform of the CP-OFDM type and the DFT-s-OFDM type. Further, the sidelink may use the following subcarrier spacing (hereinafter, ‘SCS’). For example, in frequency range (FR) 1 which uses a frequency band less than 6 GHz, SCSs of 15 kHz, 30 kHz, and 60 kHz are used and, in this case, the 60 kHz spacing, which exhibits the best performance, may be set to be used. In FR2 which uses a frequency band of 6 GHz or more, spacings of 60 kHz and 120 kHz are used, and the 60 kHz band may primarily be used.

Further, the sidelink uses a cyclic prefix (CP) to prevent modulation that may arise during the course of wireless communication transmission/reception, and its length may be set to be equal to the length of the normal CP of the NR Uu interface. If necessary, an extended CP may be applied.

In this situation, it is necessary to set the sidelink synchronization signal, resource allocation, and structure of each sidelink channel considering efficiency.

First, when the UE performs sidelink communication, the DMRS configuration included in the transmitted PSSCH is proposed.

The transmission UE may perform the step of receiving a resource information set including information about one or more sidelink resources and one or more DMRS pattern information from the base station.

In the case of sidelink communication, two types of resource allocation modes may be set. For example, in mode 1, the transmission UE requests sidelink radio resource allocation from the base station and performs sidelink communication using the sidelink radio resources allocated by the base station. In mode 2, the base station may allocate a resource information set, which is information about one or more sidelink radio resources, to the sidelink UE in advance. The UE selects a sidelink radio resource from the allocated resource information set and performs sidelink communication.

The resource information set and one or more DMRS pattern information may be received through higher layer signaling. For example, the transmission UE or reception UE located within coverage of the base station receives a resource information set including one or more sidelink resources to be used for sidelink communication through RRC signaling. Further, the transmission UE and/or the reception UE may receive one or more pieces of DMRS pattern information for sidelink communication from the base station. The resource information set and the DMRS pattern information may be configured in each UE as the transmission UE and the reception UE receive the same information.

Meanwhile, one or more pieces of DMRS pattern information may be mapped for each resource information set or sidelink resource. For example, when a first resource information set including one or more resource information and a second resource information set including one or more resource information are indicated by the base station, one first DMRS pattern information for the first resource information set and one second DMRS pattern information for the second resource information set may be mapped with the resource information set and indicated. Or, DMRS pattern information may be mapped and indicated for each sidelink resource included in one resource information set. Or, DMRS pattern information may be mapped and indicated for each of two or more sidelink resource subsets included in one resource information set. Or, two or more resource information sets may be grouped, and DMRS pattern information may be mapped and indicated for each group. Sidelink resources and DMRS patterns may be mapped and indicated in other various forms. The transmission UE configures the received resource information set and DMRS pattern in the UE.

The transmission UE may perform the step of selecting one sidelink resource for performing sidelink communication based on the resource information set. If sidelink communication is triggered, the transmission UE selects a specific sidelink resource from the configured resource information set. A method for the UE to select a specific sidelink resource within the resource information set for sidelink communication may be performed according to various criteria. For example, the transmission UE may select a specific sidelink resource according to priorities assigned to the plurality of sidelink resources. Or, the UE may sense whether resources are used for the plurality of sidelink resources and may select a sidelink resource having a sensing result value below a reference. In other words, the transmission UE may sense an unused or infrequently used sidelink resource and select a sidelink resource to be used by the transmission UE.

The transmission UE may perform the step of selecting a specific DMRS pattern from among one or more pieces of DMRS pattern information based on one selected sidelink resource. For example, when the transmission UE selects one sidelink resource, the transmission UE may select the DMRS pattern mapped and configured to the selected sidelink resource. Or, the transmission UE may select a DMRS pattern based on the feature information about the selected sidelink resource.

For example, the selected specific DMRS pattern may be determined based on persistence symbol information about the sidelink resource selected for physical sidelink shared channel (PSSCH) transmission, information about the number of symbols where the physical sidelink control channel (PSCCH) is allocated, and information about the number of DMRS symbols included in the PSSCH. Specifically, when a PSSCH sidelink resource to transmit sidelink data is selected, the persistence symbol information constituting the corresponding PSSCH sidelink resource, the number of symbols of the PSCCH allocated in the slot where the PSSCH is transmitted, and the number of DMRS symbols may be determined. In this case, the position of the symbol where the DMRS is to be transmitted may be determined according to a combination of the cases based on preconfigured information in a table form. For example, information about the number of symbols where PSCCH is allocated may be set to 2 or 3, and information about the number of symbols of DMRS included in PSSCH may be set to 2, 3 or 4. In other words, each component may be determined within the above-described number range for each sidelink resource.

The transmission UE may perform the step of transmitting the PSCCH and PSSCH in one slot using the selected sidelink resource and transmitting the DMRS in a specific symbol of the PSSCH based on a specific DMRS pattern. For example, if a sidelink resource for sidelink data transmission is determined, the transmission UE may transmit the PSCCH and PSSCH in one slot. The DMRS pattern information included in the PSSCH may be indicated to the reception UE by the sidelink control information (SCI) included in the PSCCH.

For example, specific DMRS pattern information applied to the PSSCH may be indicated by the DMRS pattern field of sidelink control information included in the PSCCH. The DMRS pattern field may be included in the 1st SCI and may be determined as any one value among 1 to 5 bits. Or, the bit value of the DMRS pattern field may be determined according to the number of pieces of DMRS pattern information transmitted by the base station. The SCI format including the DMRS pattern indication field is SCI 0_1.

The reception UE may receive sidelink data from the PSSCH sidelink resource indicated by the PSCCH and may identify the DMRS symbols allocated in the PSSCH area using the DMRS pattern indication field.

Meanwhile, when a pattern tables for DMRS allocation symbols are configured in the transmission UE and the reception UE, the DMRS pattern information included in the DMRS pattern indication field may include information indicating the number of DMRSs allocated to the PSSCH. In other words, since the number of persistence symbols of the PSSCH and the number of symbols set to the PSCCH may be identified through other fields of the SCI, the reception UE may identify the information about the symbols to which the DMRS is assigned using the table when identifying the DMRS number information. In this case, the DMRS indication field may be connected to 2 bits.

Through the above operation, the transmission UE may dynamically configure and transmit a DMRS pattern, and the reception UE may identify the dynamically configured DMRS pattern to thereby receive the PSSCH.

Next, an operation for transmitting and receiving a synchronization signal when a base station-based synchronization configuration is applied to perform sidelink communication is described.

In sidelink communication, unlike the Uu interface, there are cases in which an allocated frequency band is set relatively narrowly, and more information to be transmitted through a broadcast channel may appear. Further, slot-based synchronization signal transmission is required.

Therefore, in the disclosure, a sidelink synchronization signal block different from the synchronization signal block in the Uu interface is proposed.

The UE may perform the step of receiving sidelink synchronization block (SSB) configuration information including synchronization information for sidelink communication.

For example, the sidelink synchronization signal block configuration information may include at least one of subcarrier index information in the frequency domain in which the sidelink synchronization signal block is transmitted, information about the number of sidelink synchronization signal blocks transmitted within one sidelink synchronization signal period, offset information from the start point of the sidelink synchronization signal period to the first sidelink synchronization signal block monitoring slot, and interval information between sidelink synchronization signal block monitoring slots. For example, the sidelink synchronization signal period may be set to 16 frames and be set to 160 ms. As another example, the sidelink synchronization signal period may be set to a multiple of 16.

As another example, the number of sidelink synchronization signal blocks may be set in a differential range depending on the subcarrier spacing set in the frequency band in which sidelink synchronization signal blocks are transmitted. As described in Table 1, the subcarrier spacing in the frequency band may be set to 15, 30, 60, 120, or 240 kHz. Specifically, the number of sidelink synchronization signal blocks is set to either 1 or 2 when the subcarrier spacing is 15 kHz. Or, the number of sidelink synchronization signal blocks is set to one of 1, 2 or 4 when the subcarrier spacing is 30 kHz. Or, the number of sidelink synchronization signal blocks is set to one of 1, 2, 4 or 8 when the subcarrier spacing is 60 kHz. Or, the number of sidelink synchronization signal blocks is set to one of 1, 2, 4, 8, 16, 32 or 64 when the subcarrier spacing is 120 kHz. Meanwhile, in the case of FR2, even when subcarrier spacing is set to 60 kHz, the number of sidelink synchronization signal blocks may be set to one of 1, 2, 4, 8, 16, and 32.

The UE may perform the step of monitoring the sidelink synchronization signal block monitoring slot configured based on the sidelink synchronization signal block configuration information. For example, the UE monitors a specific slot within the sidelink synchronization signal period based on the sidelink synchronization signal block configuration information.

For example, when 16 frames are set as the sidelink synchronization signal period, the UE identifies the interval from the start slot of the sidelink synchronization signal period to the first sidelink synchronization signal block monitoring slot in the synchronization signal period based on offset information. Further, the UE identifies the interval from the first sidelink synchronization signal block monitoring slot to the second sidelink synchronization signal block monitoring slot using the interval information. Likewise, the UE identifies the interval from the second sidelink synchronization signal block monitoring slot to the third sidelink synchronization signal block monitoring slot using the interval information. Further, the UE identifies the number of all sidelink synchronization signal block monitoring slots allocated within the sidelink synchronization signal period based on information about the number of sidelink synchronization signal blocks. Therefore, the UE identifies and monitors the index (location) of the monitoring slot within the sidelink synchronization signal period using the sidelink synchronization signal block configuration information.

The UE may perform the step of receiving a sidelink synchronization signal block in a sidelink synchronization signal block monitoring slot. For example, the UE receives the sidelink synchronization signal block in the monitoring slot using the above-described sidelink synchronization signal block configuration information. The sidelink synchronization signal block is composed of a sidelink primary synchronization signal (S-PSS), a sidelink secondary synchronization signal (S-SSS), and a physical sidelink broadcast channel (PSBCH). The S-PSS, S-SSS, and PSBCH may be allocated to N contiguous symbols within the sidelink synchronization signal block monitoring slot.

For example, the sidelink synchronization signal block may be configured by being allocated to N contiguous symbols within one slot. In this case, the sidelink synchronization signal block may be connected to two S-PSSs, two S-SSSs, and N-4 PSBCH symbols. For example, the sidelink synchronization signal block may be assigned the PSBCH at symbol index 0 in the sidelink synchronization signal block monitoring slot, the S-PSS at symbol indexes 1 and 2, the S-SSS at symbol indexes 3 and 4, and the PSBCHs at symbol index 5 to symbol index N-1. In this case, N is 13 when the sidelink synchronization signal block monitoring slot is a normal cyclic prefix (CP), and N is 11 when the sidelink synchronization signal block monitoring slot is an extended cyclic prefix (CP). In other words, when one slot is composed of 14 or 12 symbols, the S-PSS, S-SSS, and PSBCH may be allocated except for the last symbol, forming the sidelink synchronization signal block. As another example, the sidelink synchronization signal block may be constituted of 132 subcarriers.

Meanwhile, HARQ operation may be performed even in sidelink communication. However, frequent HARQ operations in sidelink communication may cause issues with the superposition of resources and an increase in system load. Further, HARQ operation may not be performed smoothly due to, e.g., limitations in transmission power of the UE. Therefore, in sidelink communication, various operations may be controlled to be performed according to the HARQ feedback transmission scheme.

To this end, the UE needs to receive information about the HARQ feedback transmission scheme from the transmission UE.

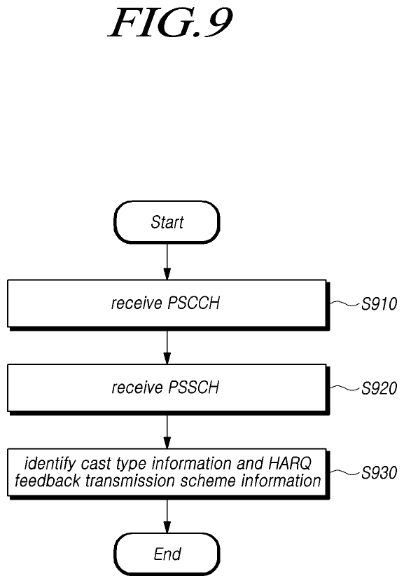

FIG. 9 is a view for describing operations of a UE according to an embodiment.

Referring to FIG. 9, the UE controlling the sidelink HARQ feedback operation performs the step of receiving a physical sidelink control channel (PSCCH) including first sidelink control information from the transmission UE (S910).

For example, the UE receives the PSCCH transmitted by the transmission UE, and the PSCCH may include first sidelink control information. The sidelink control information may be divided into first sidelink control information included in the PSCCH and second sidelink control information included in the PSSCH.

For example, the first sidelink control information may include at least one of PSSCH scheduling information, DMRS pattern information, information indicating the format of the second sidelink control information, modulation and coding scheme information, and PSFCH overhead indication information.

For example, the first sidelink control information may include information indicating the format of the second sidelink control information in a 2-bit field. The second sidelink control information format may be divided into two by the information indicating the format of the second sidelink control information.

The second sidelink control information format may provide the same or different HARQ feedback transmission schemes. In other words, the HARQ feedback transmission scheme may be divided according to the information indicating the format of the second sidelink control information.

For example, when the information indicating the format of the second sidelink control information indicates a first format, the HARQ feedback transmission scheme may be determined as one of three. As another example, when the information indicating the format of the second sidelink control information indicates a second format, the HARQ feedback transmission scheme may be determined as one of two.

For example, when the information indicating the format of the second sidelink control information indicates the first format, the HARQ feedback transmission scheme may support any one of a first scheme of transmitting HARQ feedback including ACK or NACK information depending on whether to receive sidelink data, a second scheme of transmitting HARQ feedback only when sidelink data reception is determined as NACK, and a third scheme of not transmitting HARQ feedback for sidelink data.

When the information indicating the format of the second sidelink control information indicates the second format, the HARQ feedback transmission scheme may support any one of a second scheme of transmitting HARQ feedback only when reception of the sidelink data is determined as NACK and a third scheme of not transmitting HARQ feedback for sidelink data.

The UE performs the step of receiving physical sidelink shared channel (PSSCH) including second sidelink control information from the transmission UE (S920).

For example, the UE may receive second sidelink control information through the PSSCH according to the scheduling information of the first sidelink control information. As described above, the second sidelink control information may be determined as one of two formats and be determined by the information indicating the format of the second sidelink control information of the first sidelink control information.

For example, the second sidelink control information may include an HARQ process number, new data indication information, redundancy version, source ID, destination ID, and HARQ feedback activation information. Further, it may include at least one of cast type information, CSI request indication information, zone ID, and communication range request information according to the format of the second sidelink control information.

For example, when the second sidelink control information is in the first format, it may include cast type information and CSI request indication information. As another example, when the second sidelink control information is in the second format, it may include zone ID information and communication range request information.

Meanwhile, the PSSCH may also include sidelink data information.

The UE performs the step of identifying cast type information and HARQ feedback transmission scheme information about sidelink data received from the transmission UE based on the second sidelink control information (S930).

As described above, various HARQ feedback transmission schemes may be supported in sidelink communication. For example, a first scheme that transmits HARQ feedback including ACK or NACK information depending on whether sidelink data is received, a second scheme that transmits HARQ feedback only when reception of sidelink data is determined to be NACK, and a third scheme that does not transmit HARQ feedback for sidelink data may be supported.

Based on the second sidelink control information, the UE may identify HARQ feedback transmission scheme information for sidelink data received through the PSSCH from the transmission UE.

For example, the cast type field included in the second sidelink control information may be constituted of 2 bits and may include a value indicating one of broadcast, groupcast, and unicast.

Further, the cast type field may include a plurality of values indicating group cast. Here, the plurality of the values indicating groupcast may be divided according to HARQ feedback transmission scheme information.

For example, one of the plurality of values indicating groupcast may indicate an HARQ feedback transmission scheme for transmitting HARQ feedback including ACK or NACK information according to whether sidelink data is received. As another example, another one of the plurality of values indicating groupcast may indicate an HARQ feedback transmission scheme that transmits HARQ feedback only when reception of sidelink data is determined to be NACK.

In other words, the UE may simultaneously identify cast type information for sidelink data and HARQ transmission scheme information by identifying the value of the cast type field of the second sidelink control information. To this end, different values may be assigned to the 2-bit cast type field depending on the cast type, and in the case of the group cast type, at least two values are assigned. Each of the two assigned values indicates a groupcast type, but is configured to simultaneously indicate different HARQ transmission schemes.

Therefore, the transmission UE may indicate the information about the HARQ feedback transmission scheme to the reception UE without generating an additional field and incurring system load in the sidelink communication process.

An embodiment indicating such an HARQ feedback transmission scheme is described below in greater detail. To perform the above-described HARQ feedback operation according to the disclosure, it is necessary to recognize the sidelink communication type. V2X communication types may include a unicast type performing one-to-one communication and a groupcast or broadcast type performing one-to-many communication.

As described above, the transmission UE may indicate the cast type through the second sidelink control information (2^{nd} SCI).

Meanwhile, for HARQ operation, whether to use HARQ feedback (enable, disable), communication scheme (groupcast, unicast, broadcast, etc.), and HARQ feedback transmission scheme (no feedback, ACK or NACK, NACK only) should be classified or specified.

Therefore, the transmission UE needs to transfer information about whether to use HARQ feedback and the HARQ feedback transmission scheme to the reception UE. However, when all the information is transferred using separate fields, the system load for control information may be increased, so that the radio resources for sidelink data transmission may be reduced.

To address this issue, the disclosure proposes a method for transferring information related to various types of HARQ operations.

For example, the first sidelink control information (1st SCI) may include information indicating HARQ operation.

For example, the format of the second sidelink control information may be indicated using 2 bits in the 1^{st} SCI. Depending on each format, a different supported HARQ feedback transmission scheme may be set. Therefore, a candidate for an HARQ feedback transmission scheme may be indicated according to the information indicating the format of the second sidelink control information.

Or, two bits are used in the 1^{st} SCI, and whether to use HARQ feedback and the HARQ feedback scheme ma y be indicated using the two bits. For example, referring to Table 2, the HARQ disable state indicates the no feedback state. When HARQ is enabled, the first bit may indicate the feedback scheme, and the second bit may indicate the communication scheme. In the case of unicast having less information than groupcast, an ACK or NACK feedback scheme may be indicated.

TABLE 2

| 1st SCI | |
|---|---|
| 00 | HARQ feedback not used |
| 01 | HARQ feedback used, only HARQ NACK only |
| | information used, Groupcast |
| 10 | HARQ feedback used, HARQ ACK or NACK |
| | information used, Unicast |
| 11 | HARQ feedback used, HARQ ACK or NACK |
| | information used, Groupcast |

As another example, the HARQ operation may be indicated using the two-bit field of the second side link control information (2^{nd} SCI).

For example, both the cast type and HARQ feedback transmission scheme information may be indicated using the 2-bit cast type field of the 2^{nd} SCI. For example, referring to Table 3, broadcast, groupcast, and unicast may be divided through the four values of the cast type field of the 2^{nd} SCI. In the case of groupcast, different values may be assigned to the scheme of transmitting HARQ feedback information in the case of HARQ ACK and NACK both and the scheme of transmitting HARQ feedback information only in the case of HARQ NACK.

TABLE 3

| 2nd SCI, value of | |
|---|---|
| cast type field | cast type |
| 00 | Broadcast |
| 01 | Groupcast |
| | when HARQ-ACK information includes |
| | ACK or NACK |
| 10 | Unicast |
| 11 | Groupcast |
| | when HARQ-ACK information includes |
| | only NACK |

Thus, information about HARQ operation may be transferred without increasing additional control information bits.

As another example, the information indicating the HARQ operation may be transferred through the 1^{st} SCI and 2^{nd} SCI.

For example, information about the HARQ feedback transmission scheme candidate corresponding to each format may be transferred through the information indicating the second sidelink control information format of the 1st SCI, and the HARQ operation may be indicated using the HARQ feedback transmission scheme information of the cast type field or information about whether to use the HARQ feedback in the 2^{nd} SCI.

In addition thereto, the HARQ operation may also be indicated by any combination of the above-described embodiments.

Meanwhile, as described above, the second sidelink control information may be divided into two or more formats and set. The HARQ operation according to the cast type field included in the second sidelink control information has been described above. A UE HARQ operation when the second sidelink control information includes zone ID information in the second format is described below.

The description will focus on the operation of the UE. The foregoing description which may be likewise applied below is omitted as necessary.

The UE controlling the sidelink HARQ feedback operation may perform the step of receiving groupcast sidelink data from the transmission UE through the physical sidelink shared channel (PSSCH).

In the case of groupcast communication, the PSCCH may include scheduling information for PSSCH radio resources including sidelink groupcast data. The UE receives the PSSCH including groupcast sidelink data based on sidelink control information included in the PSCCH.

The UE may perform the step of determining whether to transmit HARQ feedback information about groupcast sidelink data based on location information about the transmission UE.

For example, the location information about the transmission UE may be included in the sidelink control information (SCI) received through PSSCH and may include zone ID information about the transmission UE. The sidelink control information received through the PSSCH may mean second sidelink control information (2nd SCI). In other words, the sidelink control information received through PSSCH is distinguished from the sidelink control information received through physical sidelink control channel (PSCCH) including scheduling information for groupcast sidelink data. For example, the SCI received through PSSCH may include HARQ process ID information, new data indication information, redundancy version information, transmission UE ID information, reception UE ID information, CSI request information, zone ID information, and communication range request information.

Meanwhile, geographical location information mapped for each zone ID information may be received from the base station through higher layer signaling. The UE may obtain the location information about the transmission UE using the geographical location information for each zone ID information received from the base station and the zone ID information about the transmission UE.

Meanwhile, HARQ feedback information may be determined based on the location of the transmission UE and distance information calculated by the location of the UE and whether decoding of groupcast sidelink data is successful.

For example, the HARQ feedback information may be determined to be transmitted only when decoding of the groupcast sidelink data fails, and the distance information is a preset threshold or less and may include HARQ-NACK information.

As another example, the HARQ feedback information may be determined to be transmitted including HARQ-ACK or HARQ-NACK information depending on whether decoding of the groupcast sidelink data succeeds in the case where the distance information is the preset threshold or more.

As another example, HARQ feedback information may be determined not to be transmitted regardless of distance information when decoding of groupcast sidelink data is successful.

As another example, whether to transmit HARQ feedback information may be determined based on distance information only when decoding of groupcast sidelink data fails.

The above-described HARQ feedback information transmission may be performed only when the sidelink HARQ feedback operation is activated. In other words, the sidelink HARQ feedback operation may be activated or deactivated, and whether it is activated may be determined by indication of the transmission UE or the base station. Further, the above-described threshold may be included in the sidelink control information received through PSSCH (e.g., communication range request information) or may be configured in the UE by the base station.

Meanwhile, when transmission of HARQ feedback information is determined, the UE may perform the step of transmitting HARQ feedback information.

For example, when transmission of HARQ feedback information is determined, the UE may transmit HARQ feedback information for groupcast sidelink data. Through the above operation, it is possible to reduce unnecessary sidelink system load and provide an effect of performing HARQ feedback operation based on distance information between the transmission UE and the UE.

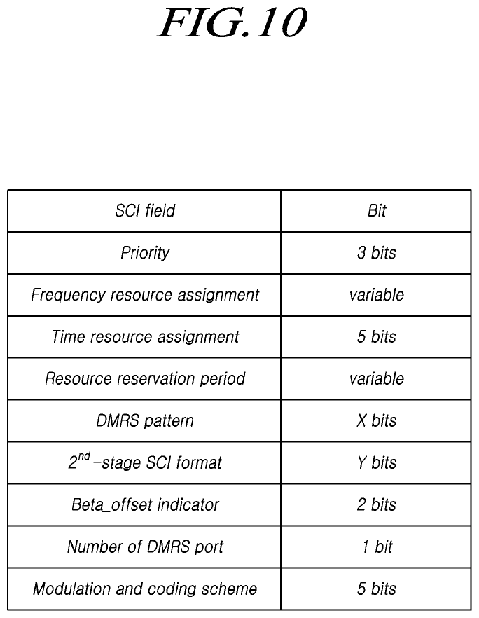

FIG. 10 is a view illustrating sidelink control information received through PSCCH according to an embodiment.

Referring to FIG. 10, sidelink control information may be transmitted through PSCCH and PSSCH. The sidelink control information transmitted through PSCCH may include, e.g., PSSCH scheduling information and be denoted as 1st SCI.

For example, the 1st SCI includes a priority field for priority, a frequency resource allocation field for PSSCH, and a time resource allocation field. Further, in the case of resource reservation, resource reservation period information is included. Further, the 1st SCI may include the above-described DMRS pattern indication field. Further, the 1st SCI may include a format field for indicating the 2nd SCI format, a beta offset indication field, a field indicating the number of DMRS ports, and a field indicating the modulation and coding scheme. Among them, the frequency and resource reservation period field may be set to vary in size, and the DMRS pattern and 2nd SCI format field may be fixed to specific bits or set to vary. The reception UE may receive the 1st SCI of FIG. 10 and identify DMRS pattern information, PSSCH scheduling information, and 2nd SCI format information.

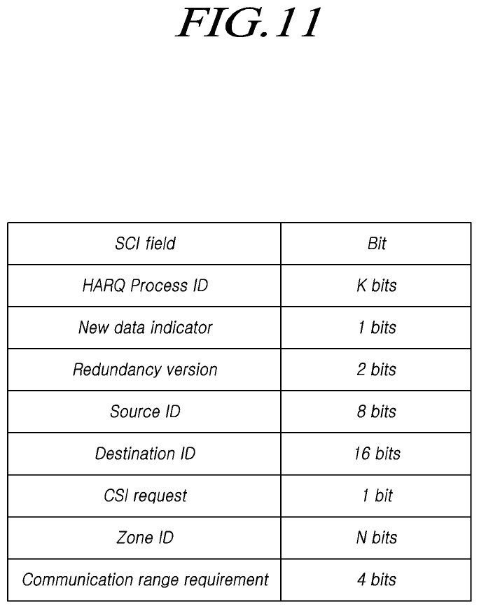

FIG. 11 is a view illustrating sidelink control information received through PSSCH according to an embodiment.

Referring to FIG. 11, the 2nd SCI received through the PSSCH may include a K-bit field including HARQ process ID information. Further, the 2nd SCI may include a 1-bit new data indication field indicating whether the data of the PSSCH is retransmission data or initial transmission data. Further, the 2nd SCI may include a 2-bit redundancy version field for HARQ process. Further, the 2nd SCI may include a source ID field including identification information about the transmission UE transmitting the PSSCH, and this field is constituted of 8 bits. Further, the 2nd SCI may include a 16-bit destination ID field including destination identification information about the PSSCH. Further, the 2nd SCI may include at least one of a 1-bit CSI request field requesting channel state information and a 4-bit communication range request field. Further, an N-bit zone ID field including location information about the above-described transmission UE may be included.

Hereinafter, various embodiments of calculating distance information between transmission UE and the UE are described with reference to drawings.

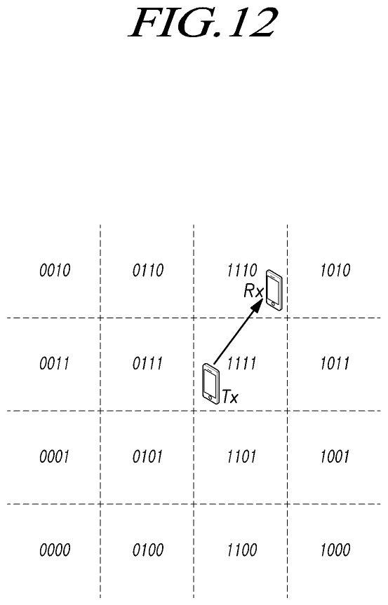

FIG. 12 is a view illustrating an operation for calculating distance information based on the locations of a transmission UE and a UE according to an embodiment.

Referring to FIG. 12, the transmission UE (Tx UE) may not consider the location of the reception UE (Rx UE). In this case, the transmission UE may transmit the SCI including the location information obtained by the GNSS or the base station. The reception UE may find out the location information about the transmission UE from the received SCI information. For example, the location information about the transmission UE may be transmitted by identification information in which the geographical location is divided into zone types.

For example, if the identification information about the geographical location information about the transmission UE is 1111, and the identification information about the geographical location information about the reception UE is 1110, the transmission UE may transmit the SCI including 4-bit zone ID information indicating 1111.

As another example, if the transmission UE knows the location of the receiving end, the transmission UE may include relative location information with the reception UE in the SCI and transmit it to the transmission UE. In this case, the relative location information about the transmission UE uses n bits, and the SCI may also include the resolution information of the location information. FIG. 12 illustrates an example in which 4 bits are used and the resolution is 10 m*10 m. In this scenario, the transmission UE may transmit the SCI including the relative location information of 1110 and the resolution information of 1110.

As another example, when GNSS information is not used, the reception UE may calculate the distance between the transmission UE and the reception UE considering sidelink path loss and transmission signal strength and compare it with a communication request range to determine whether to transmit HARQ feedback.

CQI, PMI, or RI indicating the state of the channel has the characteristic of changing depending on the degree of fading. Fading refers to a phenomenon in which two or more radio waves in different paths interfere with each other, causing the signal amplitude and phase to change irregularly over time. Particularly, small-scale fading is caused by a combination of a plurality of multi-path reflected waves generated by the influence of surrounding structures and has the characteristic of rapidly changing within a short period of time. The degree of fading is directly related to the path loss coefficient in the NLOS situation, and this is also closely related to the measured CQI, PMI, and RI. Therefore, after estimating the path loss coefficient from CQI, PMI, or RI, a more accurate distance may be calculated using the RSRP and the strength of the transmission reference signal. The relationship between the distance between the transmitting and receiving ends, the received signal strength (RSRP), the transmitted signal strength, and the path loss coefficient may be determined by a preset formula.

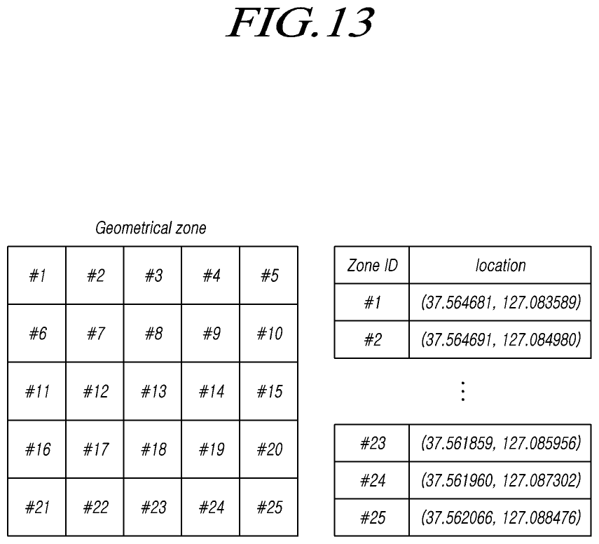

FIG. 13 is a view illustrating an operation for receiving location information about a transmission UE according to an embodiment.

Referring to FIG. 13, the transmission UE may transmit location information about the transmission UE based on the zone ID. In this case, the geographical location information corresponding to the zone ID may be configured in the form of a table in advance by the transmission UE and the reception UE.

For example, the zone ID may be configured in the form of a table through the geometrical zone. The zone ID in the form of a set table may be previously stored by the transmission UE and the reception UE. When the reception UE receives the zone ID, it may identify the geographical location information about the transmission UE. Since the geographical location information about the reception UE may be estimated through the reception UE's GNSS or base station reference signal, the reception UE may calculate distance information between the transmission UE and the reception UE if knowing the geographical location information about the transmission UE.

Meanwhile, each zone and its corresponding ID may be defined in advance as a rectangular zone as shown in FIG. 13. If the location of the transmission vehicle obtained through the GPS is in one of the predefined zones, the transmission UE determines that the ID corresponding to the corresponding zone is the zone ID of the transmission UE. The determined zone ID is included in the SCI and transmitted and may thus be used to determine whether to do HARQ feedback by the reception UE.

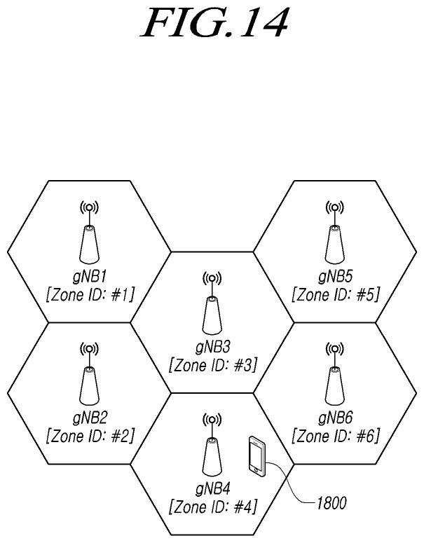

FIG. 14 is a view illustrating an operation for receiving location information about a transmission UE according to another embodiment.

Referring to FIG. 14, the zone ID may be determined based on the communication range of the base station. In this case, each UE 1800 has a zone ID based on the base station. If a UE 1800 forms an RRC connection with gNB4 and is performing communication, the zone ID of the UE 1800 may be determined as zone ID #4 corresponding to gNB4. In other words, the zone ID may be specified for each base station. In this case, the UE may transmit SCI including information indicating zone ID #4.

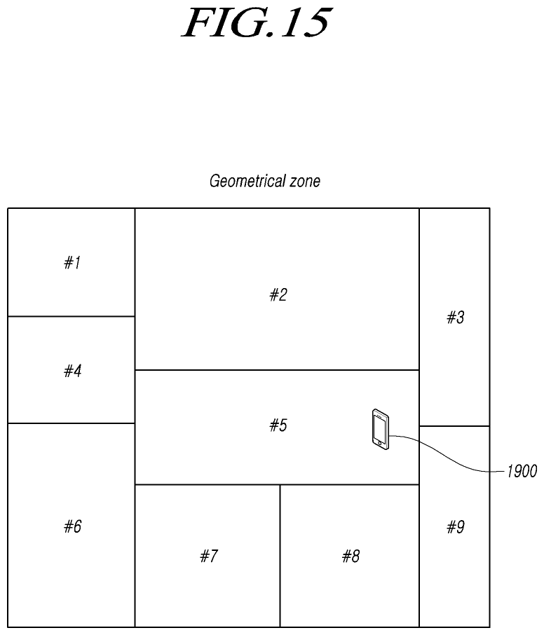

FIG. 15 is a view illustrating an operation for receiving location information about a transmission UE according to another embodiment.

Referring to FIG. 15, each zone and its corresponding zone ID may be previously defined as non-uniform zones. In the upper layer, the size of each zone may be determined considering the density of UEs according to the zone and the positioning accuracy. Information about the zone IDs of the UEs located in a specific range or UEs located in the cells of one or more specific base stations may be previously configured in each UE. If the transmission UE 1900 belongs to a specific zone, the corresponding vehicle may include the ID of the zone in the SCI and transmits it. For example, if the UE 1900 is positioned in zone #5, the UE 1900 includes information indicating #5 in the SCI and transmits it.

Meanwhile, the zone ID and communication range may be included as K and 4 bits, respectively, in the 2nd stage SCI. As described above, the zone ID information may be used for calculating the distance between TX and RX, and the communication range may be used as a threshold for HARQ feedback transmission based on the distance between TX and RX.

The reception UE calculates the TX-RX distance information using its location and the zone ID of the transmission UE. The calculated TX-RX distance information may be compared with the communication range and used to determine HARQ feedback. For example, if the TX-RX distance calculated by the reception UE in a groupcast situation is larger than the communication range, the corresponding UE does not send an ACK or NACK according to HARQ operation. In the opposite case, the corresponding UE sends an ACK or NACK. In other words, if distance information between TX and RX is calculated using the zone ID and the location of the reception UE, whether to transmit the HARQ feedback signal may be finally determined through comparison with communication range information that may be included in the SCI. The communication range information has been described as being included in the SCI. However, a specific table is previously defined, and the communication range information may include only an indication value for identifying and indicating the of the corresponding table. Or, the communication range information may be shared by UEs through higher layer signaling. In other words, the base station may transmit communication range information to each UE, and whether to perform the HARQ feedback operation may be determined based on the communication range information for a predetermined time or until before a predetermined event occurs.

As described above, information for indicating various types of HARQ operation schemes (HARQ transmission schemes) may be transferred to the reception UE in various forms according to the various types of HARQ operation schemes. The indication scheme using the cast type and the scheme using zone ID described above may be used in combination with each other. Or, each of the above-described schemes may be separately applied according to different second sidelink control information formats.

A UE device capable of performing the above-described embodiments is described below again.

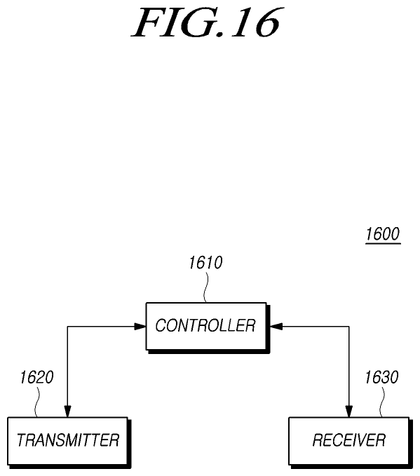

FIG. 16 is a view illustrating a configuration of a UE according to an embodiment.

Referring to FIG. 16, a UE 1600 controlling a sidelink HARQ feedback operation may include a receiver 1630 receiving a physical sidelink control channel (PSCCH) including first sidelink control information from a transmission UE and receiving a physical sidelink shared channel (PSSCH) including second sidelink control information from the transmission UE and a controller 1610 identifying HARQ feedback transmission scheme information and cast type information of sidelink data received from the transmission UE based on the second sidelink control information.

For example, the sidelink control information may be divided into first sidelink control information included in the PSCCH and second sidelink control information included in the PSSCH.

For example, the first sidelink control information may include at least one of PSSCH scheduling information, DMRS pattern information, information indicating the format of the second sidelink control information, modulation and coding scheme information, and PSFCH overhead indication information.

For example, the first sidelink control information may include information indicating the format of the second sidelink control information in a 2-bit field. The second sidelink control information format may be divided into two by the information indicating the format of the second sidelink control information.

The second sidelink control information format may provide the same or different HARQ feedback transmission schemes. In other words, the HARQ feedback transmission scheme may be divided according to the information indicating the format of the second sidelink control information.

For example, when the information indicating the format of the second sidelink control information indicates a first format, the HARQ feedback transmission scheme may be determined as one of three. As another example, when the information indicating the format of the second sidelink control information indicates a second format, the HARQ feedback transmission scheme may be determined as one of two.

For example, when the information indicating the format of the second sidelink control information indicates the first format, the HARQ feedback transmission scheme may support any one of a first scheme of transmitting HARQ feedback including ACK or NACK information depending on whether to receive sidelink data, a second scheme of transmitting HARQ feedback only when sidelink data reception is determined as NACK, and a third scheme of not transmitting HARQ feedback for sidelink data.

When the information indicating the format of the second sidelink control information indicates the second format, the HARQ feedback transmission scheme may support any one of a second scheme of transmitting HARQ feedback only when reception of the sidelink data is determined as NACK and a third scheme of not transmitting HARQ feedback for sidelink data.

The receiver 1630 may receive second sidelink control information through the PSSCH according to the scheduling information of the first sidelink control information. As described above, the second sidelink control information may be determined as one of two formats and be determined by the information indicating the format of the second sidelink control information of the first sidelink control information.

For example, the second sidelink control information may include an HARQ process number, new data indication information, redundancy version, source ID, destination ID, and HARQ feedback activation information. Further, it may include at least one of cast type information, CSI request indication information, zone ID, and communication range request information according to the format of the second sidelink control information.

For example, when the second sidelink control information is in the first format, it may include cast type information and CSI request indication information. As another example, when the second sidelink control information is in the second format, it may include zone ID information and communication range request information. Meanwhile, the PSSCH may also include sidelink data information.

As described above, various HARQ feedback transmission schemes may be supported in sidelink communication. For example, a first scheme that transmits HARQ feedback including ACK or NACK information depending on whether sidelink data is received, a second scheme that transmits HARQ feedback only when reception of sidelink data is determined to be NACK, and a third scheme that does not transmit HARQ feedback for sidelink data may be supported.

The controller 1610 may identify HARQ feedback transmission scheme information for sidelink data received through the PSSCH from the transmission UE based on the second sidelink control information.

For example, the cast type field included in the second sidelink control information may be constituted of 2 bits and may include a value indicating one of broadcast, groupcast, and unicast. Further, the cast type field may include a plurality of values indicating group cast. Here, the plurality of the values indicating groupcast may be divided according to HARQ feedback transmission scheme information.

For example, one of the plurality of values indicating groupcast may indicate an HARQ feedback transmission scheme for transmitting HARQ feedback including ACK or NACK information according to whether sidelink data is received. As another example, another one of the plurality of values indicating groupcast may indicate an HARQ feedback transmission scheme that transmits HARQ feedback only when reception of sidelink data is determined to be NACK.

In other words, the controller 1610 may simultaneously identify cast type information for sidelink data and HARQ transmission scheme information by identifying the value of the cast type field of the second sidelink control information. To this end, different values may be assigned to the 2-bit cast type field depending on the cast type, and in the case of the group cast type, at least two values are assigned. Each of the two assigned values indicates a groupcast type, but is configured to simultaneously indicate different HARQ transmission schemes.

Besides, the controller 1610 may control the operation of the UE 1600 required to perform the above-described embodiments.

Further, the transmitter 1620 and the receiver 1630 transmit/receive signals, data, and messages with the base station and another UE through a corresponding channel.

The above-described embodiments may be supported by the standard documents disclosed in IEEE 802, 3GPP, and 3GPP2 which are radio access systems. In other words, steps, components, and parts not described to clarify the technical spirit in the embodiments may be supported by the above-described standard documents. Further, all the terms disclosed in the disclosure may be described by the standard documents disclosed above.

The present embodiments described above may be implemented through various means. For example, the present embodiments may be implemented by various means, e.g., hardware, firmware, software, or a combination thereof.

When implemented in hardware, the method according to the present embodiments may be implemented by, e.g., one or more application specific integrated circuits (ASICs), digital signal processors (DSPs), digital signal processing devices (DSPDs), programmable logic devices (PLDs), field programmable gate arrays (FPGAs), processors, controllers, micro-controllers, or micro-processors.

When implemented in firmware or hardware, the method according to the present embodiments may be implemented in the form of a device, procedure, or function performing the above-described functions or operations. The software code may be stored in a memory unit and driven by a processor. The memory unit may be positioned inside or outside the processor to exchange data with the processor by various known means.

The above-described terms, such as “system,” “processor,” “controller,” “component,” “module,” “interface,” “model,” or “unit,” described above may generally refer to computer-related entity hardware, a combination of hardware and software, software, or software being executed. For example, the above-described components may be, but are not limited to, processes driven by a processor, processors, controllers, control processors, entities, execution threads, programs, and/or computers. For example, both an application being executed by a controller or a processor and the controller or the processor may be the components. One or more components may reside within a process and/or thread of execution, and the components may be positioned in one device (e.g., a system, a computing device, etc.) or distributed in two or more devices.

The above-described embodiments are merely examples, and it will be appreciated by one of ordinary skill in the art various changes may be made thereto without departing from the scope of the present invention. Accordingly, the embodiments set forth herein are provided for illustrative purposes, but not to limit the scope of the present invention, and should be appreciated that the scope of the present invention is not limited by the embodiments. The scope of the present invention should be construed by the following claims, and all technical spirits within equivalents thereof should be interpreted to belong to the scope of the present invention.

### CROSS-REFERENCE TO RELATED APPLICATION

The instant patent application claims priority under 35 U.S.C. 119(a) to Korean Patent Application Nos. 10-2020-0099444 and 10-2021-0102560, filed on Aug. 7, 2020 and Aug. 4, 2021, respectively, in the Korean Intellectual Property Office, the disclosures of which are herein incorporated by reference in their entireties. The present patent application claims priority to other applications to be filed in other countries, the disclosures of which are also incorporated by reference herein in their entireties.

What is claimed is:

1. A method for controlling a sidelink HARQ feedback operation by a UE, the method comprising:
receiving a physical sidelink control channel (PSCCH) including first sidelink control information from a transmission UE;
receiving a physical sidelink shared channel (PSSCH) including second sidelink control information from the transmission UE; and
identifying HARQ feedback transmission scheme information and cast type information of sidelink data received from the transmission UE based on the second sidelink control information.

2. The method of claim 1, wherein the HARQ feedback transmission scheme information and the cast type information of the sidelink data are indicated by a cast type field included in the second sidelink control information.

3. The method of claim 2, wherein the cast type field is constituted of two bits and includes a value indicating any one cast type among broadcast, groupcast, and unicast.

4. The method of claim 3, wherein the cast type field includes a plurality of values indicating the groupcast, and wherein the plurality of values indicating the groupcast are divided depending on the HARQ feedback transmission scheme information.

5. The method of claim 3, wherein any one of the plurality of values indicating the groupcast indicates the HARQ feedback transmission scheme transmitting HARQ feedback including ACK or NACK information depending on whether to receive the sidelink data, and wherein another one of the plurality of values indicating the groupcast indicates the HARQ feedback transmission scheme transmitting the HARQ feedback only when reception of the sidelink data is determined as NACK.

6. The method of claim 1, wherein the first sidelink control information includes information indicating a format of the second sidelink control information in a 2-bit field, and wherein the HARQ feedback transmission scheme is identified according to the information indicating the format of the second sidelink control information.

7. The method of claim 6, wherein the format of the second sidelink control information is divided into two, wherein when the information indicating the format of the second sidelink control information indicates a first format, the HARQ feedback transmission scheme is determined as any one of three, and wherein when the information indicating the format of the second sidelink control information indicates a second format, the HARQ feedback transmission scheme is determined as any one of two.

8. The method of claim 7, wherein the HARQ feedback transmission scheme when indicating the first format is any one of a first scheme of transmitting HARQ feedback including ACK or NACK information depending on whether to use the sidelink data, a second scheme of transmitting HARQ feedback only when reception of the sidelink data is determined as NACK, and a third scheme of not transmitting HARQ feedback for the sidelink data, and wherein the HARQ feedback transmission scheme when indicating the second format is either the second scheme of transmitting HARQ feedback only when reception of the sidelink data is determined as the NACK or the third scheme of not transmitting HARQ feedback for the sidelink data.

9. A UE controlling a sidelink HARQ feedback operation, comprising:
a receiver receiving a physical sidelink control channel (PSCCH) including first sidelink control information from a transmission UE and receiving a physical sidelink shared channel (PSSCH) including second sidelink control information from the transmission UE; and
a controller identifying HARQ feedback transmission scheme information and cast type information of sidelink data received from the transmission UE based on the second sidelink control information.

10. The UE of claim 9, wherein the HARQ feedback transmission scheme information and the cast type information of the sidelink data are indicated by a cast type field included in the second sidelink control information.

11. The UE of claim 10, wherein the cast type field is constituted of two bits and includes a value indicating any one cast type among broadcast, groupcast, and unicast, and wherein a plurality of values indicating the groupcast are divided depending on the HARQ feedback transmission scheme information.

12. The UE of claim 11, wherein any one of the plurality of values indicating the groupcast indicates the HARQ feedback transmission scheme transmitting HARQ feedback including ACK or NACK information depending on whether to receive the sidelink data, and wherein another one of the plurality of values indicating the groupcast indicates the HARQ feedback transmission scheme transmitting the HARQ feedback only when reception of the sidelink data is determined as NACK.

13. The UE of claim 9, wherein the first sidelink control information includes information indicating a format of the second sidelink control information in a 2-bit field, and wherein the HARQ feedback transmission scheme is identified according to the information indicating the format of the second sidelink control information.

14. The UE of claim 13, wherein the format of the second sidelink control information is divided into two, wherein when the information indicating the format of the second sidelink control information indicates a first format, the HARQ feedback transmission scheme is determined as any one of three, and wherein when the information indicating the format of the second sidelink control information indicates a second format, the HARQ feedback transmission scheme is determined as any one of two.

15. The UE of claim 14, wherein the HARQ feedback transmission scheme when indicating the first format is any one of a first scheme of transmitting HARQ feedback including ACK or NACK information depending on whether to use the sidelink data, a second scheme of transmitting HARQ feedback only when reception of the sidelink data is determined as NACK, and a third scheme of not transmitting HARQ feedback for the sidelink data, and wherein the HARQ feedback transmission scheme when indicating the second format is either the second scheme of transmitting HARQ feedback only when reception of the sidelink data is determined as the NACK or the third scheme of not transmitting HARQ feedback for the sidelink data.
